(19) United States
(12) Patent Application Publication
(10) Pub. No.: US 2005/0201262 A1
(43) Pub. Date: Sep. 15, 2005

(54) Recordable optical storage medium capable of recording data without data loss and method and apparatus for recording data thereon

(75) Inventor: Seung-hoon Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/068,858

(22) Filed: Mar. 2, 2005

(30) Foreign Application Priority Data
Mar. 10, 2004 (KR) 2004-16095

(51) Int. Cl. G11B 7/24; G11B 7/00

(52) U.S. Cl. 369/275.4; 369/44.26; 369/94

(57) ABSTRACT

A recordable optical storage medium for recording data without data loss and a method and apparatus for recording data thereon without data loss, including a plurality of recording layers for recording data by alternately forming grooves and lands, wherein recording layers whose recording tracks for recording data are formed on grooves and recording layers whose recording tracks for recording data are formed on lands are alternately formed.

### CROSS-REFERENCE TO RELATED APPLICATION

This application claims the priority of Korean Patent Application No. 2004-16095, filed on Mar. 10, 2004, in the Korean Intellectual Property Office, the disclosure of which is incorporated herein in its entirety by reference.

### BACKGROUND OF THE INVENTION

1. Field of the Invention

The present invention relates to a recordable optical storage medium and a method and an apparatus for recording data thereon, and more particularly, to a recordable optical storage medium of a double-layer structure for recording data without data loss, and a method and an apparatus for recording data thereon without data loss.

2. Description of the Related Art

A read only optical storage medium, such as DVD-ROM, has a double-layer structure to store a large amount of data. However, a recordable optical storage medium, such as DVD-RAM and DVD-R/DVD+R, is formed in a single layer structure, thus the recording capacity of DVD-RAM and DVD-R/DVD+R is less than that of DVD-ROM. Thus, it is difficult to copy data from a DVD-ROM to a recordable optical storage medium, such as DVD-RAM and DVD-R/DVD+R.

A recordable optical storage medium of a double-layer structure has been developed to solve the above-described problem. FIGS. 1A and 1B are a perspective view and a sectional view, respectively, illustrating the structure of a recordable optical storage medium of double-layer structure.

Referring to FIG. 1A, a recordable optical storage medium of a double-layer structure includes a first transparent substrate 10, a first recording layer 20, a semitransparent reflective layer 30, a spacer 40, a second recording layer 50, a metal reflective layer 60, a second transparent substrate 70, and a label layer 80.

The transparent substrates 10 and 70, which are each formed of a polycarbonate resin, protect the recording layers 20 and 50 and form the exterior of the recordable optical storage medium. The recording layers 20 and 50 are formed of a plurality of grooves 22 and 52 and a plurality of lands 24 and 54 that are alternately formed. In addition, predetermined dye (not shown), which is sensitively changed according to temperature, is coated or applied on the recording layers 20 and 50. The semitransparent reflective layer 30 reflects a portion of a laser beam to read data, which is recorded on the first recording layer 20, while passing another portion of the laser beam to the second recording layer 50 to record/read data on/from the second recording layer 50.

The conventional recordable optical storage medium of double-layer structure uses the grooves 22 and 52 as recording tracks, thus, for example, the predetermined dye is coated on the surfaces of the grooves 22 and 52 only. Thus, when recording data on the first recording layer 20 of the conventional recordable optical storage medium of double-layer structure, an optical pickup (not shown) performs a tracking operation while focusing on the grooves 22 of the first recording layer 20 and forms recording marks on the grooves 22. In addition, when recording data on the second recording layer 50, the optical pickup performs a tracking operation while focusing on the grooves 52 of the second recording layer 50 and forms recording marks on the grooves 52. The structure and the recording capacity of such a conventional recordable optical storage medium of double-layer structure are the same or substantially similar as the structure and the recording capacity of a read only optical storage medium of double-layer structure, such as DVD-ROM. Therefore, the conventional recordable optical storage medium may be compatible with the read only optical storage medium of double-layer structure.

However, when the focus of the laser beam is formed on the second recording layer 50, not on the first recording layer 20, caused by disturbance, while recording data on the first recording layer 20, or the focus of the laser beam is formed on the first recording layer 20 while recording data on the second recording layer 50, the existing data is damaged, e.g., the area on which data will be recorded is damaged, resulting in the impossibility of recording data.

Thus, a method of recording data on both the lands and the grooves has been proposed to provide the same recording capacity as a read only optical storage medium of double-layer structure by using the conventional recordable optical storage medium of single layer structure. However, the track pitch of a storage medium using such a method is different from the track pitch of a conventional storage medium, which records data on the grooves only, thus a separate optical system is needed. For example, the storage medium having data recorded on both the lands and the grooves is not compatible with the conventional read only optical storage medium, such as DVD-ROM.

### SUMMARY OF THE INVENTION

The present invention provides a recordable optical storage medium capable of recording data without data loss and a method and an apparatus for recording data thereon without data loss even when a focusing error occurs due to disturbance.

The present invention also provides a recordable optical storage medium compatible with a conventional read only optical storage medium of double-layer structure.

According to an embodiment of the invention, there is provided a recordable optical storage medium including a plurality of recording layers for recording data by alternately forming recording tracks on grooves and lands, alternatively, wherein a one of the recording layers whose has recording tracks formed on grooves for recording data are formed on grooves and the other another of the recording layers whose has recording tracks formed on lands for recording data are formed on lands are alternately formed.

According to an embodiment of the invention, the grooves and lands of a one of the recording layers is in phase with the grooves and lands of the other recording layers.

According to an embodiment of the invention, the grooves and lands of a one of the recording layers have has a phase difference of about 180° with the grooves and lands of the adjacent recording layers.

According to an embodiment of the invention, the number of the recordable optical storage medium has two recording layers is two.

According to another embodiment of the invention, there is provided a method of recording data on a recordable optical storage medium having a plurality of recording layers for recording data on which grooves and lands are alternately formed, the method including recording data on grooves of at least one portion of the plurality of recording layers; and recording data on lands of the other portion at least another of the plurality of recording layers.

According to an embodiment of the invention, the recording layers on which the data is recorded on the grooves and the recording layers on which the data is recorded on the lands are alternately formed.

According to an embodiment of the invention, the recording layers is are in phase with the grooves and lands of the other recording layers, respectively.

According to an embodiment of the invention, the grooves and lands of a one of the recording layers have has a phase difference of about 180° with the grooves and lands of the adjacent recording layers.

According to yet another embodiment of the invention, there is provided a recording/reproducing apparatus of for recording/reproducing data on/from a recordable optical storage medium having a plurality of recording layers for recording data on which grooves and lands are alternately formed, the apparatus including a pickup unit having a light source radiating directing a light beam to the optical storage medium and a photodetector receiving the light beam reflected from the optical storage medium, a signal process unit detecting signals for tracking from the light beam received by the photodetector, and a control unit controlling the tracking of the pickup unit according to the signals detected by the signal process unit, wherein the control unit records/reproduces data by controlling the tracking of the pickup unit along the grooves of a portion at least one of the plurality of recording layers and records/reproduces data by controlling the tracking of the pickup unit along the lands of the other portion of the plurality at least one other of the plurality of recording layers.

According to an embodiment of the invention, the at least one recording layers on which the data is recorded on the grooves and the at least one other of the recording layers on which the data is recorded on the lands are alternately formed.

According to still another embodiment of the invention, there is provided a multi-recording layer medium having data recorded on recording tracks provided on grooves and tracks alternatively formed on each of the recording layers, including a recording layer having recording tracks formed on the grooves, an adjacent recording layer having recording tracks formed on the lands, wherein the grooves of the recording layer have a phase difference of about 180 degrees with the lands of the adjacent recording layer.

According to still another embodiment of the invention, there is provided a multi-recording layer medium having data recorded on recording tracks provided on grooves and tracks alternatively formed on each of the recording layers, including a recording layer having recording tracks formed on the grooves, an adjacent recording layer having recording tracks formed on the lands, wherein the grooves of the recording layer are in phase with the lands of the adjacent recording layer.

According to another embodiment of the invention, there is provided a method of recording/reproducing data from a multi-recording layer medium having data recorded on recording tracks provided on grooves and tracks alternatively formed on each of the recording layers, including recording/reproducing data from grooves formed on one of the recording layers, recording/reproducing data from lands formed on an adjacent recording layer, wherein the grooves of the one recording layer have a phase difference of about 180 degrees with the lands of the adjacent recording layer.

According to another embodiment of the invention, there is provided a method of recording/reproducing data from a multi-recording layer medium having data recorded on recording tracks provided on grooves and tracks alternatively formed on each of the recording layers, including recording/reproducing data from grooves formed on one of the recording layers, recording/reproducing data from lands formed on an adjacent recording layer, wherein the grooves of the one recording layer are in phase with the lands of the adjacent recording layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a perspective view illustrating a conventional recordable optical storage medium having a double-layer structure;

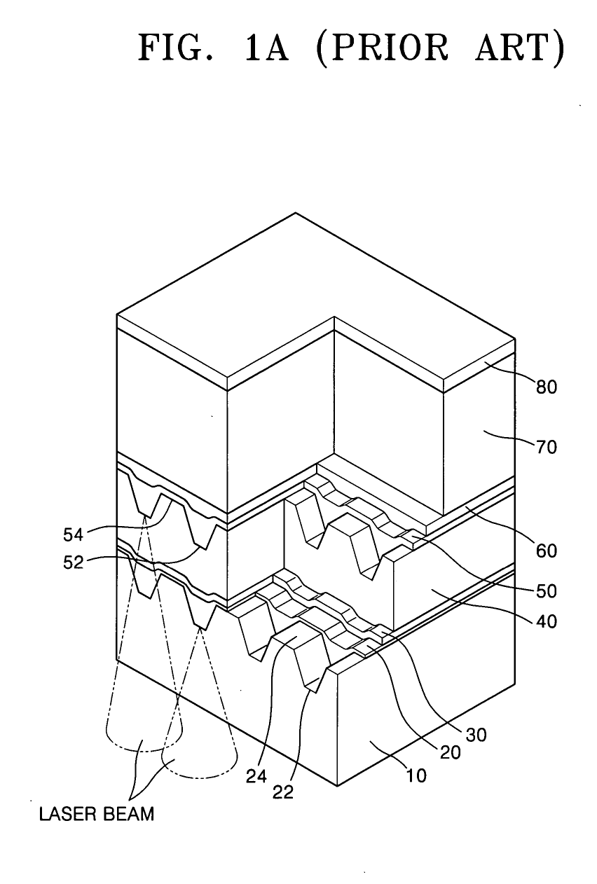

FIG. 1B is a sectional view illustrating a conventional recordable optical storage medium having a double-layer structure;

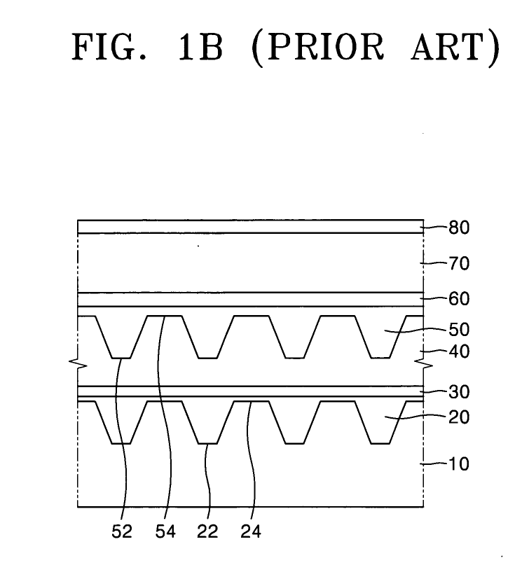

FIGS. 2A and 2B illustrate a method of recording data on a recordable optical storage medium according to embodiments of the invention;

FIGS. 3A and 3B illustrate a method of recording data on a recordable optical storage medium according to further embodiments of the invention;

FIG. 4 illustrates an optical recording/reproducing apparatus according to an embodiment of the invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

According to an embodiment of the invention, recording tracks are formed on lands of a recording layer while forming recording tracks on grooves of another recording layer, in order to prevent data loss even when a focused layer is changed caused by disturbance.

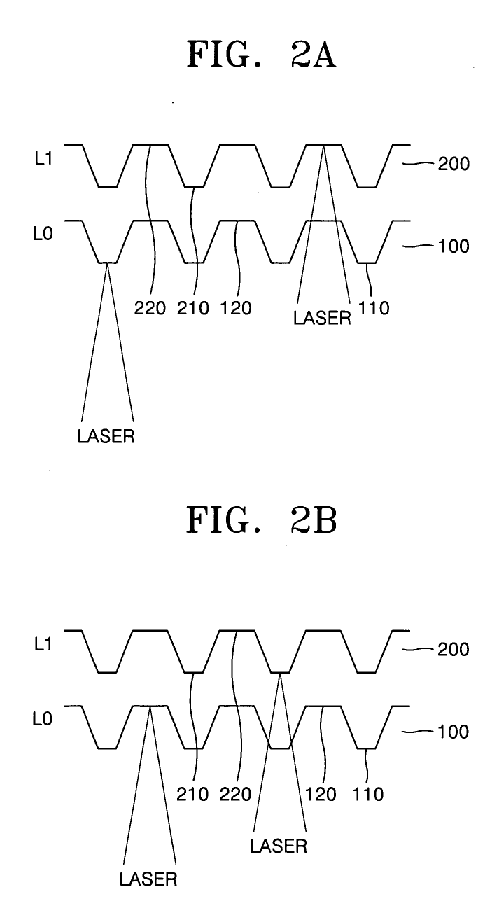

FIGS. 2A and 2B illustrate a method of recording data on a recordable optical storage medium according to embodiments of the invention.

Hereafter, a method of recording data on a recordable optical storage medium according to an embodiment of the invention is described with reference to FIG. 2A. In a conventional optical storage medium, recording tracks are formed on the grooves of each recording layer. However, referring to FIG. 2A, recording tracks are formed on grooves 110 of a first recording layer 100 and on lands 220 of a second recording layer 200. Thus, when recording data on the first recording layer 100, a laser beam is focused on the grooves 110, and when recording data on the second recording layer 200, the laser beam is focused on the lands 220, or vice-versa.

The structure of the recordable optical storage medium of double-layer structure according to the above described embodiment of the invention is similar to the structure of the conventional recordable optical storage medium having a double-layer structure. However, dye for recording data is coated on the surfaces of the grooves 110 of the first recording layer 100. In addition, the dye for recording data is coated on the surfaces of the lands 220, of the second recording layer 200.

Accordingly, when the laser beam focusing is transferred to the second recording layer 200 due to disturbance while recording data on the grooves 110 of the first recording layer 100, the laser beam focusing is located on grooves 210 of the second recording layer 200. Since the data is recorded on the lands 220 of the second recording layer 200, data loss does not occur regardless of disturbance. On the contrary, when the focusing is transferred to the first recording layer 100 due to disturbance while recording data on the lands 220 of the second recording layer 200, the focusing is located on lands 120 of the first layer 100. Thus, the grooves 110, as the recording tracks of the first recording layer 100, are not affected from disturbance.

In another embodiment of the invention shown in FIG. 2B, recording tracks are formed on lands 120 of a first recording layer 100 and grooves 210 of a second recording layer 200. Thus, a laser beam is focused on the lands 120 of the first recording layer 100 to record data on the first recording layer 100, and the laser beam is focused on the grooves 210 of the second recording layer 200 to record data on the second recording layer 200. The structure of a recordable optical storage medium of double-layer structure according to the another embodiment of the invention is the same as the structure of the recordable optical storage medium according to the above-described embodiment of the invention, except that dye for recording data is coated on the surfaces of the lands 120 of the first recording layer 100 and the surfaces of the grooves 210 of the second recording layer 200. It is understood that the recording tracks may be formed on grooves 110 of the first recording layer 100 and lands 220 of the second recording layer 200.

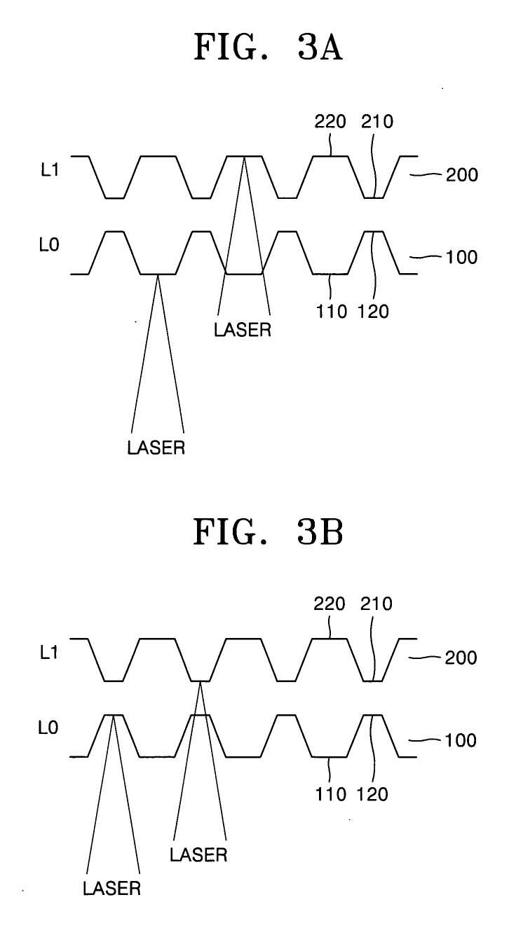

FIGS. 3A and 3B illustrate a method of recording data on a recordable optical storage medium according to further embodiments of the invention. In the previously described embodiments of the invention, the first recording layers 100 are arranged in phase with the second recording layers 200. In other embodiments of the invention, for example, the embodiments shown in FIGS. 3A and 3B, the recording tracks of the first and second recording layers 100 and 200 are formed on different locations, such as the lands and grooves, thus the recording tracks of the first and second recording layers 100 and 200 have a phase difference of approximately 180°. In this case, a conventional apparatus of recording/reproducing data should be modified to record/reproduce data on/from such a recordable optical storage medium of double-layer structure. Therefore, the first recording layers 100 and second recording layers 200 may be arranged to have a phase difference of approximately 180°. As a result, the recording tracks of the first recording layers 100 are arranged in phase with the second recording layers 200.

A method of recording data on a recordable optical storage medium according to an embodiment of the invention is described with reference to FIG. 3A. Referring to FIG. 3A, a first recording layer 100 and a second recording layer 200 of a recordable optical storage medium of double-layer structure are arranged with a phase difference of 180°. Recording tracks are formed on grooves 110 of the first recording layer 100 and on lands 220 of the second recording layer 200. Thus, dye for recording data is coated on the surfaces of the grooves 110 of the first recording layer 100 and the surfaces of the lands 220 of the second recording layer 200. Accordingly, when recording data on the first recording layer 100, a laser beam is focused on the grooves 110 of the first recording layer 100, and when recording data on the second recording layer 200, the laser beam is focused on the lands 220 of the second recording layer 200.

When the focusing is transferred to the second recording layer 200 due to disturbance while recording data on the grooves 110 of the first recording layer 100, the focusing is located on the lands 220 of the second recording layer 200. However, when the focusing is temporarily transferred to the second recording layer 200, a pickup of an optical recording apparatus is controlled to perform a tracking operation following the grooves 110 of the first recording layer 100. Thus, the pickup recognizes the lands 220 of the second recording layer 200 by using a push-pull signal and promptly moves the focusing of the laser beam to grooves 210 of the second recording layer 200. As a result, the lands 220 forming the recording tracks of the second recording layer 200 are not affected. Similarly, when the focusing is transferred to the first recording layer 100 due to disturbance while recording data on the lands 220 of the second recording layer 200, the focusing is located on the grooves 110 of the first recording layer 100. Then, the pickup promptly moves the focusing of the laser beam to lands 120 of the first recording layer 100. As a result, the grooves 110 forming the recording tracks of the first recording layer 100 are not affected.

In another embodiment of the invention, for example, as shown in FIG. 3B, first and second recording layers 100 and 200 are arranged to have a phase difference of approximately 180°. However, recording tracks are formed on lands 120 of the first recording layer 100 and grooves 210 of the second recording layer 200. Accordingly, dye for recording data is coated on the surfaces of the lands 120 of the first recording layer 100 and the surfaces of the grooves 210 of the second recording layer 200. When recording data on the first recording layer 100, a laser beam is focused on the lands 120 of the first recording layer 100, and when recording data on the second recording layer 200, the laser beam is focused on the grooves 210 of the second recording layer 200.

When the focusing of the laser beam is transferred to the second recording layer 200 due to disturbance while recording data on the lands 120 of the first recording layer 100, the focusing is located on the grooves 210 of the second recording layer 200. Here, a pickup promptly moves the focusing of the laser beam to lands 220 of the second recording layer 200. Accordingly, the grooves 210 forming the recording tracks of the second recording layer 200 are not affected.

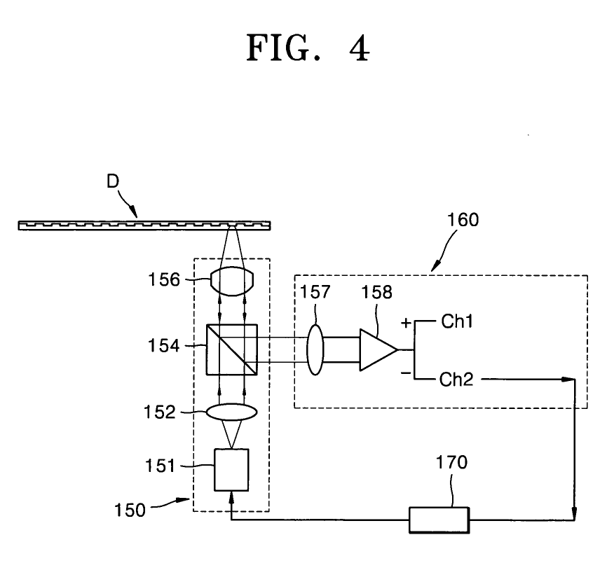

An optical recording/reproducing apparatus of recording/reproducing data on/from a recordable optical storage medium according to an embodiment of the invention is described with reference to FIG. 4. Referring to FIG. 4, the optical recording/reproducing apparatus includes a pickup unit 150, a signal process unit 160, and a control unit 170. Specifically, the pickup unit 150 includes a laser diode 151 radiating a laser beam, a collimating lens 152 of collimating the laser beam radiated from the laser diode 151, a beam splitter 154 converting the path of the laser beam, and an object lens 156 of concentrating the beam from the beam splitter 154 on an optical storage medium D.

The beam reflected on the optical storage medium D is reflected by the beam splitter 154 and received by a photodetector in the signal process unit 160, for example, a 4-division photodetector 157. The laser beam received by the photodetector 157 is converted to electric signals by an operation circuit unit 158. The electric signals are output as RF signals, e.g., a channel 1 (CH1) signal detected as a sum signal and a channel 2 (CH2) signal as a differential signal of detecting a push-pull type signal. The push-pull type signal is transferred to the control unit 170 and used as a signal for controlling the tracking of the pickup unit 150 by determining between grooves and lands of an optical storage medium.

In other words, the control unit 170 analyzes the push-pull signal, which is detected by the signal process unit 160, and controls the pickup unit 150 to perform a tracking operation along the grooves or the lands. For example, according to embodiments of the invention, such as those shown in FIGS. 2A and 3A, the control unit 170 controls the pickup unit 150 to perform the tracking operation along the grooves 110 of the first recording unit 100 to record/reproduce data on/from the first recording layer 100. The control unit 170 controls the pickup unit 150 to perform the tracking operation along the lands 220 of the second recording layer 200 to record/reproduce data on/from the second recording layer 200. On the contrary, according to other embodiments of the invention, such as those shown in FIGS. 2B and 3B, the control unit 170 controls the pickup unit 150 to perform the tracking operation along the lands 120 of the first recording unit 100 to record/reproduce data on/from the first recording layer 100. The control unit 170 controls the pickup unit 150 to perform the tracking operation along the grooves 210 of the second recording layer 200 to record/reproduce data on/from the second recording layer 200.

In the above descriptions of the invention, an optical storage medium of double-layer structure is described; however, the invention may be applied to an optical storage medium of multiple-layer structure having more than two layers. For example, when there is an optical storage medium of four-layer structure, data may be recorded on grooves of a first recording layer, on lands of a second recording layer, on grooves of a third recording layer, and on lands of a fourth recording layer.

According to the invention, the recording capacity of a recordable optical storage medium may be increased, and the recordable optical storage medium may operate with a conventional read only optical storage medium, such as DVD-ROM.

According to embodiments of the invention, when a laser beam is focused on a recording layer, which is a recording layer other than a recording layer on which data is presently recorded, due to disturbance, recording tracks of the recording layer other than the recording layer on which the data is presently recorded are not affected. Thus, data may be recorded without data loss even when the laser beam is out focused due to disturbance.

Although a few embodiments of the present invention have been shown and described, it would be appreciated by those skilled in the art that changes may be made in these embodiments without departing from the principles and spirit of the invention, the scope of which is defined in the claims and their equivalents.

1. A recordable optical storage medium comprising:
a plurality of recording layers for recording data by forming recording tracks on grooves and lands, alternatively,
wherein one of the recording layers has recording tracks formed on grooves for recording data and another recording layer has recording tracks formed on lands for recording data.

2. The recordable optical storage medium of claim 1, wherein the grooves and lands of the one recording layer is in phase with the grooves and lands of the other recording layer.

3. The recordable optical storage medium of claim 1, wherein the grooves and lands of the one recording layers has a phase difference of about 180° with the grooves and lands of adjacent recording layers.

4. The recordable optical storage medium of claim 1, wherein the recordable optical storage medium has two recording layers.

5. A method of recording data on a recordable optical storage medium having a plurality of recording layers for recording data the method comprising:
recording data on grooves of at least one of the plurality of recording layers; and
recording data on lands of at least another recording layer of the plurality of recording layers.

6. The method of recording data on a recordable optical storage medium of claim 5, wherein the one recording layer on which the data is recorded on the grooves and the other recording layer on which the data is recorded on the lands are alternately formed.

7. The method of recording data on a recordable optical storage medium of claim 6, wherein the grooves and lands of the one recording layer are in phase with the grooves and lands of the other recording layer, respectively.

8. The method of recording data on a recordable optical storage medium of claim 6, wherein the grooves and lands of the one recording layer has a phase difference of about 180° with grooves and lands of adjacent recording layers.

9. A recording/reproducing apparatus for recording/reproducing data on/from a medium having a plurality of recording layers for recording data on which grooves and lands are alternately formed, the apparatus comprising:
a pickup unit having a light source directing a light beam to the medium;
a photodetector receiving the light beam reflected from the medium;
a signal process unit detecting signals for tracking the light beam received by the photodetector; and
a control unit controlling a tracking of the pickup unit according to the signals detected by the signal process unit,
wherein the control unit controls the recording/reproducing of data by controlling the tracking of the pickup unit along grooves of at least one of the plurality of recording layers and records/reproduces data by controlling the tracking of the pickup unit along lands of at least one other recording layer of the plurality of recording layers.

10. The recording/reproducing apparatus of claim 9, wherein the at least one recording layer on which the data is recorded on the grooves and the at least other recording layer on which the data is recorded on the lands are alternately formed.

11. A multi-recording layer medium having data recorded on recording tracks provided on grooves and tracks alternatively formed on each recording layer of the medium, comprising:
a recording layer having recording tracks formed on grooves;
an adjacent recording layer having recording tracks formed on lands;
wherein the grooves of the recording layer have a phase difference of about 180 degrees with the lands of the adjacent recording layer.

12. The multi-recording layer medium of claim 11, wherein a predetermined dye, which is sensitively changed according to temperature, is coated or applied on each of the recording layers.

13. The multi-recording layer medium of claim 11, wherein a laser beam is reflected on the grooves of the recording layer to record/reproduce data on the first layer and/or the laser beam is reflected on the lands of the adjacent storage layer to record/reproduce data on the adjacent storage layer.

14. The multi-recording layer medium of claim 11, wherein the multi-recording layer medium has four recording layers such that data is recorded on grooves of a first recording layer, lands of a second recording layer, grooves of a third recording layer, and lands of a fourth recording layer.

15. A multi-recording layer medium having data recorded on recording tracks provided on grooves and tracks alternatively formed on each recording layer of the medium, comprising:
a recording layer having recording tracks formed on grooves;
an adjacent recording layer having recording tracks formed on lands;
wherein the grooves of the recording layer are in phase with the lands of the adjacent recording layer.

16. The multi-recording layer medium of claim 15, wherein a predetermined dye, which is sensitively changed according to temperature, is coated or applied on each of the recording layers.

17. The multi-recording layer medium of claim 15, wherein a laser beam is reflected on the grooves of the recording layer to record/reproduce data on the recording layer and/or the laser beam is reflected on the lands of the adjacent storage layer to record/reproduce data on the adjacent storage layer.

18. A method of recording/reproducing data from a multi-recording layer medium having data recorded on recording tracks provided on grooves and tracks alternatively formed on each recording layer of the medium, comprising:
recording/reproducing data from grooves formed on one of the recording layers;
recording/reproducing data from lands formed on an adjacent recording layer;
wherein the grooves of the one recording layer have a phase difference of about 180 degrees with the lands of the adjacent recording layer.

19. A method of recording/reproducing data from a multi-recording layer medium having data recorded on recording tracks provided on grooves and tracks alternatively formed on each recording layer of the medium, comprising:
recording/reproducing data from grooves formed on one of the recording layers;
recording/reproducing data from lands formed on an adjacent recording layer;
wherein the grooves of the one recording layer are in phase with the lands of the adjacent recording layer.
